(19) United States
(12) Patent Application Publication
(10) Pub. No.: US 2020/0296503 A1
(43) Pub. Date: Sep. 17, 2020

(54) SPEAKER DEVICE

(71) Applicant: Chicony Electronics Co., Ltd., New Taipei City (TW)

(72) Inventors: Chih-Hsiang HSU, New Taipei City (TW); Ching-Chung CHEN, New Taipei City (TW)

(21) Appl. No.: 16/546,289

(22) Filed: Aug. 20, 2019

(30) Foreign Application Priority Data
Mar. 15, 2019 (TW) 108108963

(51) Int. Cl. H04R 1/34; H04R 1/02; H04R 1/28

(52) U.S. Cl. CPC H04R 1/345; H04R 1/021; H04R 1/025; H04R 1/2834; H04R 1/023

(57) ABSTRACT

A speaker device includes an external housing, a sound guide structure, and a speaker unit. The sound guide structure is located in the external housing and has a paraboloid. The speaker unit is located in the external housing and configured to sound towards the paraboloid. The paraboloid has a focus. The speaker unit has a sound emitting surface. The center of the sound emitting surface is substantially coincident with the focus.

### CROSS-REFERENCE TO RELATED APPLICATION

This application claims priority to Taiwan Application Serial Number 108108963, filed Mar. 15, 2019, which is herein incorporated by reference.

### BACKGROUND

### Technical Field

The present disclosure relates to a speaker device.

### Description of Related Art

In the case of a traditional speaker device, a configuration that turns the sound direction of the speaker unit toward the user is adopted, such that the sound is directed toward the user and the sound loss rate is low. However, the disadvantage is that the sound box is behind the speaker unit, which occupies a large area at the bottom.

Another traditional speaker device is designed with a configuration that the speaker unit is placed upright (i.e. the sound direction faces upward or downward), so the bottom area can be smaller than the previous traditional speaker device. The speaker unit of this kind of traditional speaker device is not directly oriented toward the user, so it often needs to guide sound through a sound guide structure to form a unidirectional sound field or a non-directional sound field fixed at 360 degrees. However, the conventional sound guide structure adopted by the traditional speaker device will cause a lot of sound loss during the process of guiding the sound, so the volume will be significantly reduced, and the higher the coverage, the more muffled the sound will be.

However, the sound fields of the two kinds of traditional speaker devices are fixed and cannot be adjusted. Accordingly, how to provide a speaker device to solve the aforementioned problems becomes an important issue to be solved by those in the industry.

### SUMMARY

An aspect of the disclosure is to provide a speaker device which can solve the aforementioned problems.

According to an embodiment of the disclosure, a speaker device includes an external housing, a sound guide structure, and a speaker unit. The sound guide structure is located in the external housing and has a paraboloid. The speaker unit is located in the external housing and configured to sound towards the paraboloid. The paraboloid has a focus. The speaker unit has a sound emitting surface. A center of the sound emitting surface is substantially coincident with the focus.

In an embodiment of the disclosure, the paraboloid further has an axis passing through the focus. An acute angle is formed between the axis and a virtual section passing through the center.

In an embodiment of the disclosure, the acute angle is from about 25 degrees to about 35 degrees.

In an embodiment of the disclosure, the speaker device further includes a cushioning member. The external housing includes a top base. The cushioning member is disposed between the top base and the sound guide structure.

In an embodiment of the disclosure, the speaker device further includes an internal housing. The internal housing is located in the external housing and engaged with the sound guide structure and the speaker unit.

In an embodiment of the disclosure, the external housing includes a top base. The sound guide structure is located between the internal housing and the top base. The internal housing has an upper opening facing toward the sound guide structure. The speaker unit is engaged with the upper opening.

In an embodiment of the disclosure, the speaker device further includes a cushioning member. The external housing includes a bottom base. The cushioning member is disposed between the bottom base and the internal housing.

In an embodiment of the disclosure, the speaker device further includes a passive diaphragm engaged with the internal housing. The passive diaphragm and the speaker unit are located at opposite sides of the internal housing respectively.

In an embodiment of the disclosure, the external housing includes a bottom base. The internal housing is located between the sound guide structure and the bottom base. The internal housing has a lower opening facing toward the bottom base. The passive diaphragm is engaged with the lower opening.

In an embodiment of the disclosure, the bottom base further has a base recess. The internal housing correspondingly has a housing recess at a lower side thereof. The cushioning member is accommodated in a space between the base recess and the housing recess. The cushioning member is a spring.

Accordingly, in the speaker device of the present disclosure, the speaker unit is placed upright, so the bottom area of the housing can be smaller than traditional speaker devices. In addition, the sound guide structure adopted in the present disclosure has a paraboloid, and the speaker unit is configured to sound towards the paraboloid. Hence, the paraboloid of the sound guide structure can effectively reduce the number of reflection of sound, and effectively reduce the chance of sound colliding after being guided, thereby reducing the sound loss. Furthermore, in the speaker device of the present disclosure, the cushioning members are disposed between the external housing and the sound guide structure and between the external housing and the internal housing engaged with the speaker unit. Hence, the cushioning members can effectively absorb the vibration directly or indirectly generated by the speaker unit, thereby minimizing the abnormal sound.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1A is a perspective view of a speaker device according to an embodiment of the disclosure;

FIG. 1B is an exploded view of the speaker device in FIG. 1A;

FIG. 2 is a cross-sectional view of the speaker device in FIG. 1A taken along line 2-2, in which a mesh hood is omitted; and

FIG. 3 is a cross-sectional view of the speaker device in FIG. 1A taken along line 3-3.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts. However, specific structural and functional details disclosed herein are merely representative for purposes of describing example embodiments, and thus may be embodied in many alternate forms and should not be construed as limited to only example embodiments set forth herein. Therefore, it should be understood that there is no intent to limit example embodiments to the particular forms disclosed, but on the contrary, example embodiments are to cover all modifications, equivalents, and alternatives falling within the scope of the disclosure.

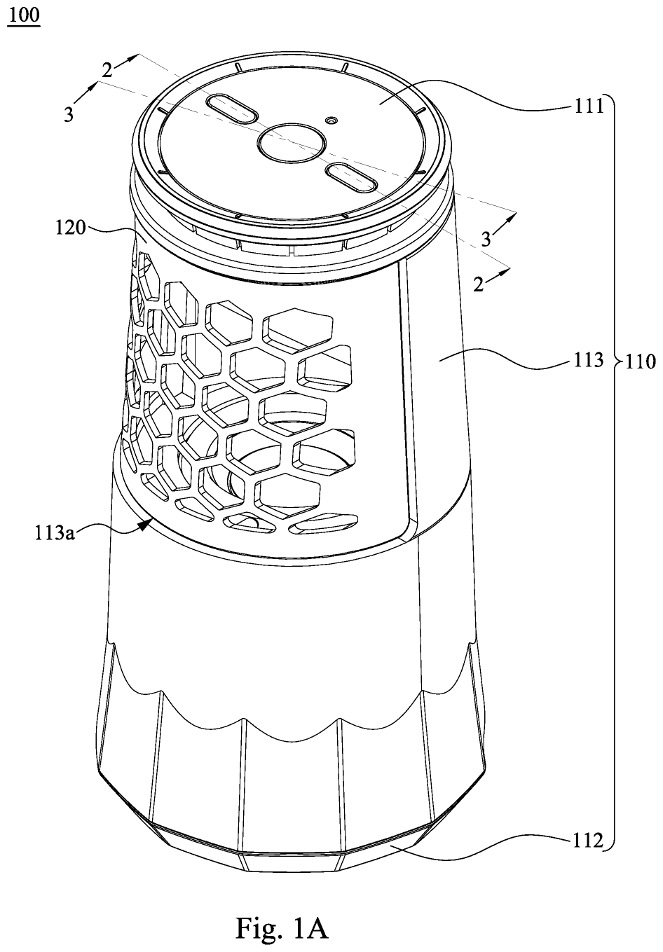

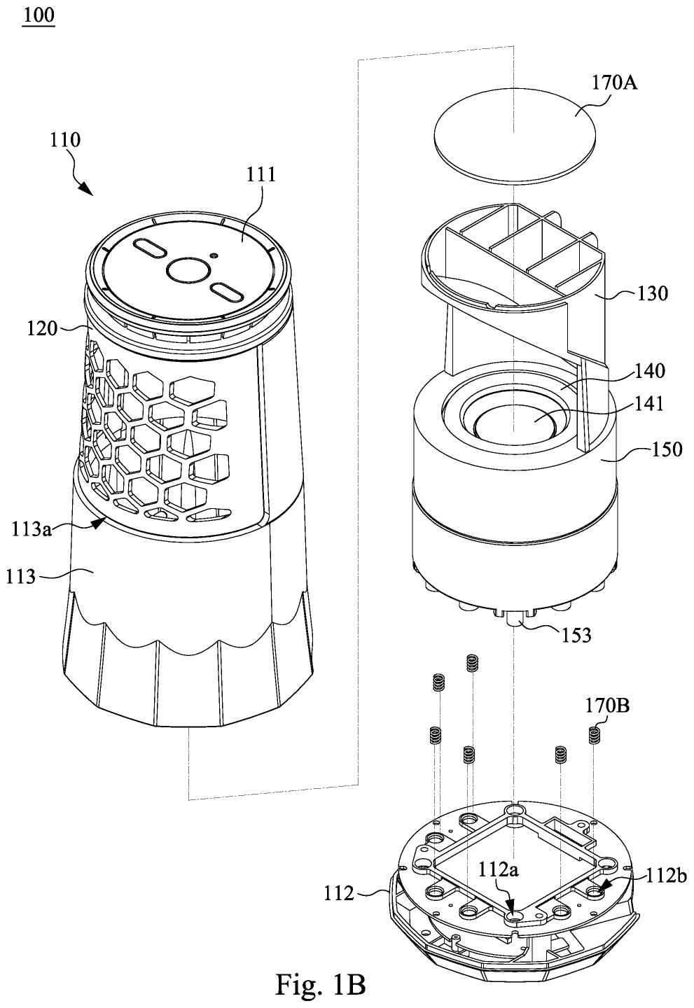

Reference is made to FIGS. 1A and 1B. FIG. 1A is a perspective view of a speaker device 100 according to an embodiment of the disclosure. FIG. 1B is an exploded view of the speaker device 100 in FIG. 1A. In the present embodiment, the speaker device 100 includes an external housing 110, a mesh hood 120, a sound guide structure 130, a speaker unit 140, and an internal housing 150, in which the combination of the speaker unit 140 and the internal housing 150 can be called a speaker unit module. This modular design contributes to the elimination of vibration and abnormal noise, which will be explained in detail later. The structure and function of each component and connection relationships among these components will be described in detail below.

As shown in FIGS. 1A and 1B, in the present embodiment, the external housing 110 includes a top base 111, a bottom base 112, and a side wall 113. The top base 111 and the bottom base 112 are opposite to each other, and the side wall 113 is connected between the top base 111 and the bottom base 112. The side wall 113 has an assembly opening 113a. The assembly opening 113a is in spatial communication with the inner space of the external housing 110. The mesh hood 120 entirely covers the assembly opening 113a and is engaged with the inner edge of the assembly opening 113a. That is, the inner space of the external housing 110 is in spatial communication with the outside of the external housing 110 via the mesh hood 120. The sound guide structure 130, the speaker unit 140, and the internal housing 150 are located in the external housing 110.

In the present embodiment, the side wall 113 and the bottom base 112 of the external housing 110 are detachably connected to each other by, for example, screw fastening, but the disclosure is not limited in this regard.

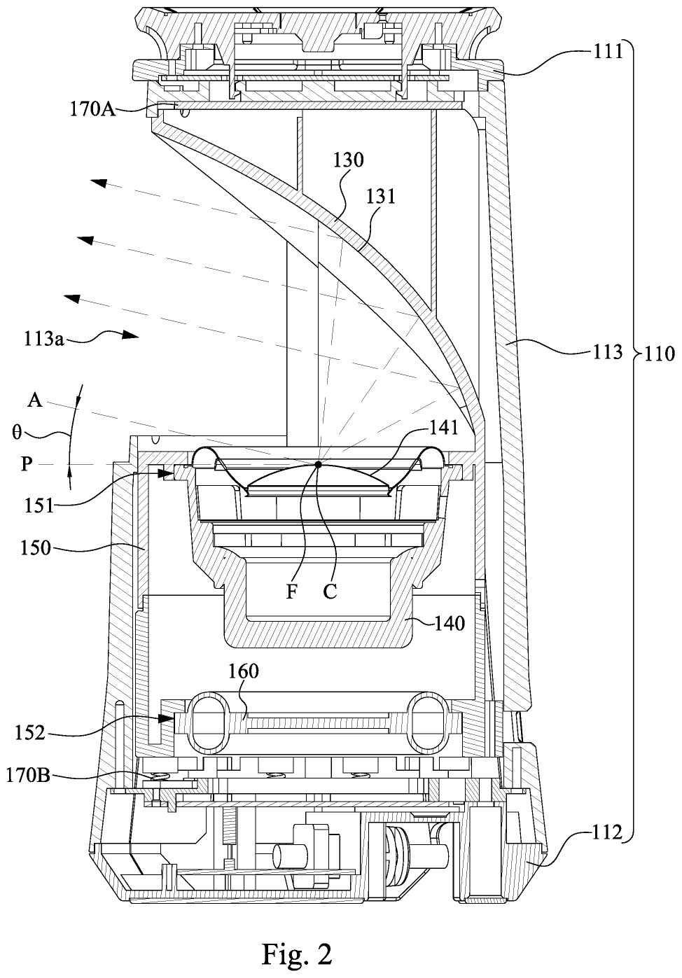

Reference is made to FIG. 2. FIG. 2 is a cross-sectional view of the speaker device 100 in FIG. 1A taken along line 2-2, in which the mesh hood 120 is omitted. As shown in FIGS. 1B and 2, in the present embodiment, the sound guide structure 130 has a paraboloid 131. The speaker unit 140 is configured to sound towards the paraboloid 131. In detail, the paraboloid 131 of the sound guide structure 130 must conform to a parabolic equation. A parabolic equation for the Cartesian coordinate system is as follows:

z+c=x²/a²+y²/b² (1)

Where x, y, and z are three-dimensional coordinates, and a, b, and c are arbitrary constants. The disclosure requires a=b so as to obtain a paraboloid of revolution.

Furthermore, the paraboloid 131 has a focus F and an axis A passing through the focus F. The paraboloid 131 is a curved surface produced by rotating a parabola about the axis A (i.e., the axis of symmetry) by 180 degrees. The speaker unit 140 has a sound emitting surface 141. A center C of the sound emitting surface 141 is substantially coincident with the focus F. Hence, the sound emitted from the center C of the sound emitting surface 141 will travel in a direction parallel to the axis A after being reflected by the paraboloid 131. As such, the paraboloid 131 of the sound guide structure 130 can effectively reduce the number of reflection of the sound, and effectively reduce the chance of sound colliding after being guided, thereby reducing the sound loss.

In addition, in order to further reduce the collision of the sound guided by the sound guide structure 130 with the sound from the speaker unit 140 coming from below, the sound guide structure 130 can also be designed to guide the sound slightly upward. Specifically, as shown in FIG. 2, It can be further designed to form an acute angle 8 between the axis A of the paraboloid 131 and a virtual section P passing through the center C of the sound emitting surface 141, in which the axis A passes through the assembly opening 113a of the side wall 113. In some embodiments, the acute angle 8 between the axis A and the virtual section P is from about 25 degrees to about 35 degrees, but the disclosure is not limited in this regard.

As shown in FIG. 2, in the present embodiment, the internal housing 150 is engaged with the sound guide structure 130 and the speaker unit 140. Specifically, the internal housing 150 has an upper opening 151 at the upper side thereof. The speaker unit 140 is accommodated in the internal housing 150 and engaged with the inner edge of the upper opening 151, such that the sound emitting surface 141 of the speaker unit 140 exposes from the upper opening 151. The sound guide structure 130 is connected to the upper side of the internal housing 150 and opposite to the sound emitting surface 141 of the speaker unit 140. For example, the speaker unit 140 is a component that converts electrical energy into sound. The component consists, for example, of a diaphragm, a magnet, and a coil. When a current containing a signal is transmitted to the coil of the speaker unit 140, the coil generates a magnetic field. This magnetic field will drive the magnet on the diaphragm to cause the diaphragm to vibrate. This vibration pushes the surrounding air and produces sound.

In addition, the speaker device 100 further includes passive diaphragm 160. The internal housing 150 has a lower opening 152 at the lower side thereof. The passive diaphragm 160 and the speaker unit 140 are located at opposite sides of the internal housing 150 respectively. The passive diaphragm 160 is engaged with the inner edge of the lower opening 152. The passive diaphragm 160 can be made of an elastic material (e.g., rubber) and can be selected according to the use. When the speaker unit 140 vibrates, the gas in the internal housing 150 vibrates together. Since the moving path of the gas is proportional to the inner space, the passive diaphragm 160 can additionally increase the moving path, so that a cavity volume required for the internal housing 150 can be effectively reduced. For example, in the case where the passive diaphragm 160 is not engaged and the lower opening 152 is canceled, the internal housing 150 may require a cavity volume of 150 to 200 c.c. to achieve sound requirements, but in an embodiment in which the lower opening 152 is engaged with the passive diaphragm 160, the internal housing 150 may only require a cavity volume of 100 c.c. to achieve the sound requirements.

In the present embodiment, the sound guide structure 130 is connected to the internal housing 150 to form a unitary structure that is integrally formed (e.g., by a plastic injection molding process), but the disclosure is not limited in this regard.

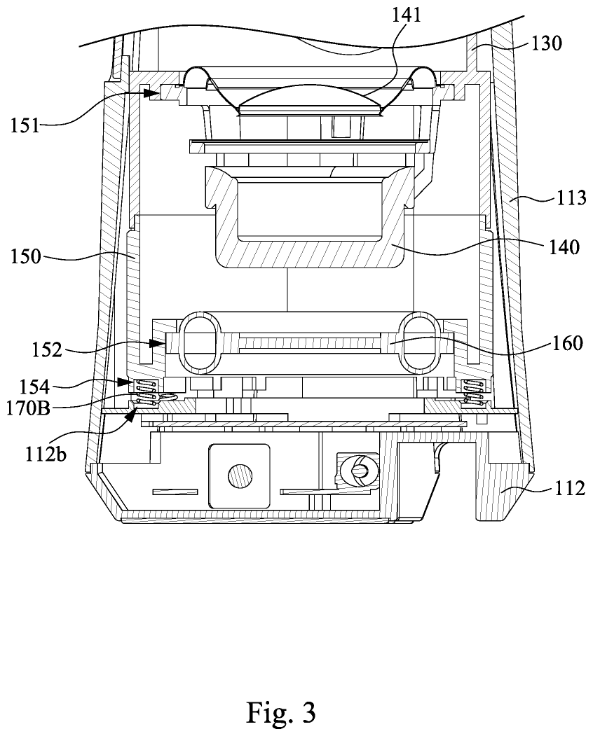

Reference is made to FIG. 3. FIG. 3 is a cross-sectional view of the speaker device 100 in FIG. 1A taken along line 3-3. As shown in FIGS. 1B to 3, in the present embodiment, the speaker device 100 further includes cushioning members 170A, 170B. The cushioning member 170A is disposed between the top base 111 of the external housing 110 and the sound guide structure 130. The cushioning members 170B are disposed between the bottom base 112 of the external housing 110 and the internal housing 150. In this way, when playing large volume through the speaker unit 140, the cushioning members 170A, 170B effectively absorb the vibration directly or indirectly generated by the speaker unit 140, thereby reducing the abnormal noises between the external housing 110 and the sound guide structure 130 and between the external housing 110 and the internal housing 150 to the minimum.

In the present embodiment, the cushioning member 170A is exemplified by a sheet-shaped cushioning material such as muffling foam, and the cushioning members 170B are exemplified by springs, but the disclosure is not limited in this regard. In addition, the number of the cushioning members 170B is not limited by FIG. 1B and can be elastically increased or decreased according to actual needs.

As shown in FIG. 1B, in the present embodiment, the internal housing 150 has a plurality of guide pillars 153 (only one of which can be seen in the figure) at the lower side thereof, and the bottom base 112 of the external housing 110 correspondingly has a plurality of guide holes 112a. The guide pillars 153 are slidably engaged with the guide holes 112a respectively, so as to limit the lateral movement of the internal housing 150 relative to the external housing 110.

In addition, as shown in FIGS. 1B and 3, in the present embodiment, the bottom base 112 of the external housing 110 further has a plurality of base recesses 112b, and the internal housing 150 correspondingly has a plurality of housing recesses 154 at a lower side thereof. The base recesses 112b are opposite to the housing recesses 154 respectively, and each of the cushioning members 170B is accommodated in a space between a corresponding one of the base recesses 112b and a corresponding one of the housing recesses 154, so as to position each of the cushioning members 170B between the bottom base 112 of the external housing 110 and the internal housing 150.

According to the foregoing recitations of the embodiments of the disclosure, it can be seen that in the speaker device of the present disclosure, the speaker unit is placed upright, so the bottom area of the housing can be smaller than traditional speaker devices. In addition, the sound guide structure adopted in the present disclosure has a paraboloid, and the speaker unit is configured to sound towards the paraboloid. Hence, the paraboloid of the sound guide structure can effectively reduce the number of reflection of sound, and effectively reduce the chance of sound colliding after being guided, thereby reducing the sound loss. Furthermore, in the speaker device of the present disclosure, the cushioning members are disposed between the external housing and the sound guide structure and between the external housing and the internal housing engaged with the speaker unit. Hence, the cushioning members can effectively absorb the vibration directly or indirectly generated by the speaker unit, thereby minimizing the abnormal sound.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A speaker device, comprising:
an external housing;
a sound guide structure located in the external housing and having a paraboloid; and
a speaker unit located in the external housing and configured to sound towards the paraboloid,
wherein the paraboloid has a focus, the speaker unit has a sound emitting surface, and a center of the sound emitting surface is substantially coincident with the focus.

2. The speaker device of claim 1, wherein the paraboloid further has an axis passing through the focus, and an acute angle is formed between the axis and a virtual section passing through the center.

3. The speaker device of claim 2, wherein the acute angle is from about 25 degrees to about 35 degrees.

4. The speaker device of claim 1, further comprising a cushioning member, wherein the external housing comprises a top base, and the cushioning member is disposed between the top base and the sound guide structure.

5. The speaker device of claim 1, further comprising an internal housing located in the external housing and engaged with the sound guide structure and the speaker unit.

6. The speaker device of claim 5, wherein the external housing comprises a top base, the sound guide structure is located between the internal housing and the top base, the internal housing has an upper opening facing toward the sound guide structure, and the speaker unit is engaged with the upper opening.

7. The speaker device of claim 5, further comprising a cushioning member, wherein the external housing comprises a bottom base, and the cushioning member is disposed between the bottom base and the internal housing.

8. The speaker device of claim 5, further comprising a passive diaphragm engaged with the internal housing, the passive diaphragm and the speaker unit being located at opposite sides of the internal housing respectively.

9. The speaker device of claim 8, wherein the external housing comprises a bottom base, the internal housing is located between the sound guide structure and the bottom base, the internal housing has a lower opening facing toward the bottom base, and the passive diaphragm is engaged with the lower opening.

10. The speaker device of claim 7, wherein the bottom base further has a base recess, the internal housing correspondingly has a housing recess at a lower side thereof, the cushioning member is accommodated in a space between the base recess and the housing recess, and the cushioning member is a spring.
